(19) United States
(12) Patent Application Publication
(10) Pub. No.: US 2025/0360957 A1
(43) Pub. Date: Nov. 27, 2025

(54) PARKING STRUCTURE AND CHILD STROLLER

(71) Applicant: WONDERLAND SWITZERLAND AG, Steinhausen (CH)

(72) Inventor: Xiaolong YI, Dongguan, Guangdong (CN)

(21) Appl. No.: 18/872,717

(22) PCT Filed: Jun. 5, 2023
(86) PCT No.: PCT/EP2023/064989

§ 371 Date: Dec. 6, 2024

(30) Foreign Application Priority Data
Jun. 8, 2022 (CN) 202210644748.X

(51) Int. Cl. B62B 9/08

(52) U.S. Cl. CPC B62B 9/087; B62B 9/082

(57) ABSTRACT

The application discloses a parking structure including: a locking structure, capable of switching between a locked position that prevents a wheel from rotating and a released position that allows the wheel to rotate; and a drive structure, connected to the locking structure; wherein the drive structure is capable of being driven from an initial position to an active position, and automatically returning from the active position to the initial position, so as to perform a reciprocating motion, and one reciprocating motion of the drive structure causes the locking structure to switch from the released position to the locked position or from the locked position to the released position. A child stroller is also disclosed.

### CROSS-REFERENCE TO RELATED APPLICATIONS

This application is a National Stage application of PCT/EP2023/064989, entitled “PARKING STRUCTURE AND CHILD STROLLER” and filed on Jun. 5, 2023, which claims the benefit of Chinese Application No. 202210644748.X, filed on Jun. 8, 2022, both of which are incorporated herein by reference in their entirety.

### TECHNICAL FIELD

The application relates to a parking structure and a child stroller including the parking structure.

### BACKGROUND

In the prior art, a locking mechanism for the wheels of the child stroller comprises a wheel, a wheel shaft rotatably connected to the wheel, and a plurality of locking slots arranged in a ring shape on the wheel. A parking pedal connected to the frame is arranged on a side of the wheel. When the pedal is stepped down, a parking block connected to the pedal is inserted into one of the locking slots, such that the wheel cannot rotate. When unlocking is required, it is necessary to hook up the parking pedal with the instep, such that the parking block is separated from the locking slot. Such locking mechanism has two reversed actions, i.e., an upward action and a downward action, to be performed in operating, which is inconvenient to operate with feet and easy to damage and stain the instep, especially when wearing shoes with exposed instep.

For this, it is necessary to propose a parking structure, which allows the wheel to be reliably locked and unlocked by stepping down the pedal unilaterally.

### SUMMARY

A parking structure according to the application comprises: a locking structure, capable of switching between a locked position that prevents a wheel from rotating and a released position that allows the wheel to rotate; and a drive structure, connected to the locking structure; characterized in that the drive structure is capable of being driven from an initial position to an active position, and automatically returning from the active position to the initial position, so as to perform a reciprocating motion, and one reciprocating motion of the drive structure causes the locking structure to switch from the released position to the locked position or from the locked position to the released position.

In an embodiment, the locking structure includes: a braking part, connected to the drive structure, capable of being brought by the drive structure to move between a locked position and a released position, so as to lock or release the wheel; and a clamping part, capable of moving between a blocked position and an unblocked position, and the clamping part in the blocked position keeps the braking part in the locked position.

In an embodiment, the locking structure further includes: an actuating part, joined to the braking part and the clamping part, during a process of the braking part moving from the released position to the locked position, the actuating part brings the clamping part to the blocked position, and during a process of the braking part moving from the locked position to the released position, the actuating part brings the clamping part to the unblocked position.

In an embodiment, the clamping part is disposed in an accommodating cavity of a housing, and capable of reciprocating along a first axis between a first axial position close to the braking part and a second axial position far away from the braking part and rotating around the first axis along a rotation direction, thereby switching between the first rotational position and the second rotational position; the accommodating cavity of the housing is configured to allow the clamping part in the first rotational position to move to the first axial position and the second axial position, and to prevent the clamping part in the second rotational position from moving to the first axial position; and the actuating part is disposed between the braking part and the clamping part, and capable of abutting against the clamping part to make the clamping part rotate along the rotation direction and move towards the second axial position.

In an embodiment, the clamping part includes: a plurality of ratchet portions, protruding toward the actuating part at an end of the clamping part facing the actuating part, and arranged at intervals along a circumferential direction of the clamping part, each of the ratchet portions includes a first ratchet tooth and a second ratchet tooth arranged in sequence along the rotation direction; and a clamping part slot, disposed between adjacent ratchet portions and extends along the first axis; wherein a rib corresponding to a position of the clamping part slot is disposed on an inner wall of the accommodating cavity, and the rib extends along the first axis, such that: when the clamping part is in the first rotational position, the clamping part slot is engaged to the rib, and when the clamping part is in the second rotational position, the clamping part slot is separated from the rib and one of the second ratchet teeth abuts against an end face of the rib.

In an embodiment, the clamping part has a cylindrical shape around the first axis, each of the first ratchet teeth and each of the f second ratchet teeth has a ratchet tooth face extending radially; the ratchet tooth faces of the first ratchet teeth and the second ratchet teeth are all inclined in a same direction in respect to the first axis, strokes of the ratchet tooth faces of the first ratchet teeth in the circumferential direction are smaller than strokes of the ratchet tooth faces of the second ratchet teeth in the circumferential direction, and a front end of each of the ratchet tooth faces in the rotation direction is closer to the actuating part, while a rear end in the rotation direction is further away from the actuating part.

In an embodiment, the ratchet portions further includes: first peaks formed at the front ends of the first ratchet teeth; second peaks formed at the front ends of the second ratchet teeth; and the first peaks and the second peaks are basically located on a same cross section in respect to the first axis.

In an embodiment, the actuating part includes: an actuating part first end, abutting against a pressing portion of the braking part; an actuating part second end, opposite to the actuating part first end along the first axis; and a plurality of actuating teeth, arranged on the actuating part second end at intervals in the circumferential direction, protruding toward the clamping part, and capable of abutting against the first ratchet teeth and the second ratchet teeth of the clamping part.

In an embodiment, in the actuating part, for each portion of the first ratchet teeth and the second ratchet teeth, there is one of the actuating teeth correspondingly arranged; and the tooth face of each of the actuating teeth includes a first bevel and a second bevel connected to each other, the first bevel is located at the rear along the rotation direction and has a relative large slope and a relative small circumferential stroke, the second bevel is located at the front along the rotation direction and has a relative small slope and a relative large circumferential stroke.

In an embodiment, the tooth faces of the actuating teeth and the ratchet tooth faces of the first ratchet teeth and the second ratchet teeth abut against each other.

In an embodiment, a radial dimension of an outer circumference of each of the actuating teeth is smaller than a radial dimension of an inner circumference of the rib.

In an embodiment, the actuating part has a substantially cylindrical shape, and further includes: an actuating part flange, disposed close to an enlarged diameter portion of the actuating part second end; and an actuating part slot, arranged, accordingly with the clamping part slot, at the actuating part flange, so as to be engaged to the rib, thereby limiting movement of the actuating part along the first axis.

In an embodiment, the braking part is disposed in a receiving cavity of the housing, capable of rotating around a second axis between the locked position and the released position, at least partially approximately sector-shaped, and includes: a raised portion, rising to one side along the second axis on a sector-shaped disk surface; a recessed portion, adjacent to the raised portion in a circumferential direction, and recessed toward the other side opposite to the raised portion; a pressing portion, located outside one end of the sector, and arranged to abut against the actuating part; and a traction member second end joining portion, arranged near the pressing portion to join a traction member second end of a traction member, and a traction member first end of the traction member is joined to the drive structure, such that the braking part is capable of being pulled by the traction member to move between the locked position and the released position; and the locking structure further includes a locking pin, and the locking pin is arranged to be capable of moving in the housing along the second axis; and when the braking part is in the locked position, the locking pin abuts against the raised portion and extends out of the housing to be inserted into a corresponding slot of the wheel, so as to lock the wheel, and when the braking part is in the released position, the locking pin abuts against the recessed portion and retracts into the housing to release the wheel.

In an embodiment, the braking part further includes a first indicating portion and a second indicating portion respectively located on a sector-shaped outer peripheral surface of the braking part; and the housing further includes a transparent or hollowed indicator window opened at an outer periphery corresponding to the first indicating portion and the second indicating portion of the braking part, so as to display one of the first indicating portion and the second indicating portion; wherein when the braking part is in the released position, the first indicating portion is located at the indicator window, and when the braking part is in the locked position, the second indicating portion is located at the indicator window.

In an embodiment, the second axis is substantially perpendicular to the first axis and coincides with a rotation axis of the wheel.

In an embodiment, the drive structure includes a traction member; and the traction member includes: a traction member first end, joined to the drive structure; a traction member second end, joined to the braking part; and a traction member engagement portion, capable of being engaged in the clamping part; wherein when the clamping part is in the blocked position, the clamping part pulls the traction member through the traction member engagement portion, so as to prevent the braking part from moving back from the locked position corresponding to the blocked position to the released position.

In an embodiment, the parking structure further includes: a clamping part elastic member, disposed between the clamping part and the housing or the wheel seat connected to the housing, and biasing the clamping part to the first axial position; and a locking pin elastic member, disposed between the locking pin and the housing, and biasing the locking pin to be retracted into the housing.

In an embodiment, the drive structure includes: a sleeve, arranged in a lateral direction on a crossbeam of the frame connected to the wheel; a pedal, sleeved outside the sleeve, capable of being stepped to rotate around the sleeve, a pedal channel is arranged on an inner wall of the pedal, and the pedal channel includes a slanted portion extending perpendicular to the lateral direction; and a slider, disposed slidably along the lateral direction in sleeve, a slider pin is inserted into the slider, and one end of the slider pin is inserted into the pedal channel and capable of moving relatively in the pedal channel; and wherein when the pedal is stepped, interaction between the slider pin and the pedal channel causes the slider to pull the traction member toward a center of the sleeve.

In an embodiment, the drive structure further includes: an abutting member, the abutting member and the pedal are respectively formed into semi-cylindrical bodies, such that they are capable of being abutted with each other to form a tubular structure and sleeved outside the sleeve together; and an abutting member channel is disposed on an inner side of the abutting member and extends obliquely in a direction opposite to the pedal channel, and another end of the slider pin is inserted into the abutting member channel and capable of moving relatively in the abutting member channel.

A child stroller according to the application comprises: a frame; at least one wheel, joined below the frame; and the parking structure according to the application.

### BRIEF DESCRIPTION OF THE DRAWINGS

FIG. 1 is a perspective view of a wheelset of a child stroller according to the application, in which a pedal is in an initial position;

FIG. 2 is a perspective view of the wheelset, in which the pedal is stepped down to be in an active position;

FIG. 3 is a perspective view of the wheelset from the other angle, in which a wheel on one side is removed from each set of wheels to show a parking structure;

FIG. 4 is a perspective view of a wheel;

FIG. 5 is a perspective view of a wheelset, in which the wheels and a part of a housing of a locking structure of the parking structure are removed;

FIG. 6 is a partial enlarged view at the box in FIG. 5;

FIG. 7 is a perspective view of the wheelset, in which the wheel, a wheel seat, and a part of the housing are removed, and in which a braking part and an actuating part are in a released position;

FIG. 8 is a partial enlarged view at the box in FIG. 7;

FIG. 9 is a perspective view of the wheelsets, in which the wheels the wheel seat, and a part of the housing are removed, and in which the braking part and the actuating part are in a locked position;

FIG. 10 is a partial enlarged view at the box in FIG. 9;

FIG. 11 is a perspective view of the housing;

FIG. 12 is a top view of the housing;

FIG. 13 is a perspective view of the housing from the other angle;

FIG. 14 is a partially sectioned perspective view of the housing, and shows a locking pin, a braking part, an actuating part, and a clamping part disposed in the housing;

FIG. 15 is a perspective view of the actuating part and the clamping part;

FIG. 16 is a perspective view of the clamping part;

FIG. 17 is a bottom view of the clamping part;

FIGS. 18A to 18E are schematic bottom views showing a rotation process of the clamping part;

FIG. 19 is a perspective side view of the parking structure with a part of the housing removed, in which the braking part and the actuating part are in the released position;

FIG. 20 is a partially cut-away side view of the parking structure, in which the braking part and the actuating part are in the locked position;

FIG. 21 is a partially enlarged cross-sectional view of the block in FIG. 20, in which different cross-sectional lines are added to some parts for the purpose of clearness;

FIG. 22 is a perspective side view of the parking structure with a part of the housing removed, in which the braking part and the actuating part are in the locked position;

FIG. 23 is a perspective view of the wheelset, in which a pedal and an abutting member are shown in an exploded state;

FIG. 24 is a perspective view of the wheelset, in which respective parts of a drive structure are shown in an exploded state;

FIG. 25 is a perspective view of the pedal;

FIG. 26 is a partially sectioned view of the drive structure, in which the pedal is removed to show an internal structure of the drive structure, and in which a slider is in a non-pulled position;

FIG. 27 is a front view of the drive structure, in which the pedal is removed to show the internal structure of the drive structure, and in which the slider is in a pulled position;

FIG. 28 is a perspective view of the drive structure, in which the pedal is in the initial position;

FIG. 29 is a perspective view of the drive structure, in which the pedal is in the active position.

### DETAILED DESCRIPTION

Although the present invention has been illustrated and described herein with reference to specific embodiments, it should not be limited to the details shown. Rather, various modifications may be made to these details within the scope of equivalents of the claims without departing from the invention.

In the present application, directional descriptions such as “front,” “back,” “upper” and “lower” are only used for the convenience of understanding. The invention is not limited to these directions but can be adjusted according to the actual situation. Moreover, although the application is described with reference to typical embodiments, the terms used are illustrative and exemplary, not restrictive.

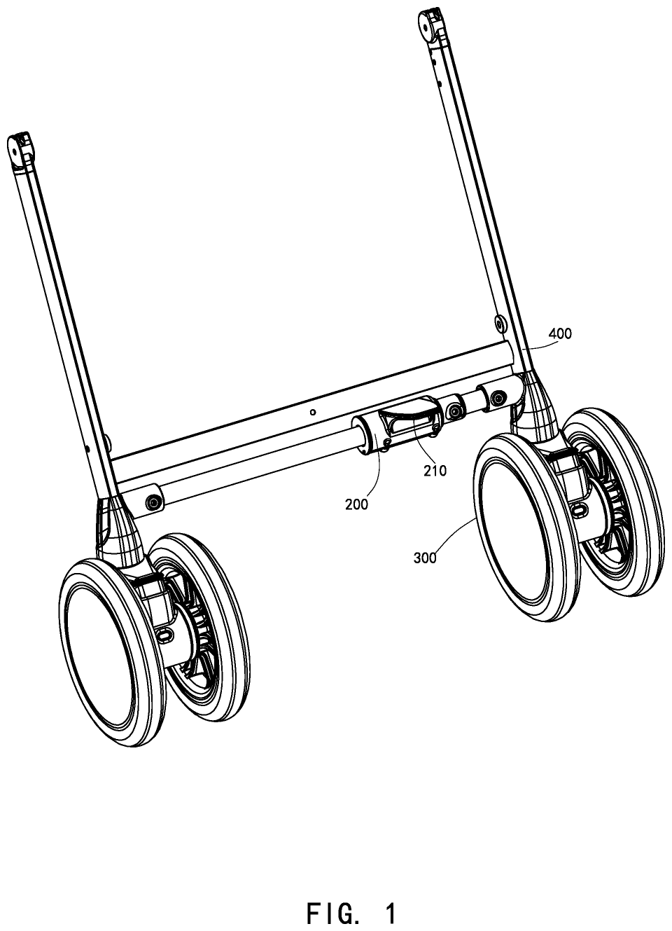

Referring to FIGS. 1 to 5, a child stroller according to the application will be described generally. The child stroller includes a frame 400 a traveling mechanism such as wheels 300 disposed below the frame 400. Only a part of the frame 400 connected to a set of the wheels 300 is shown in the drawings of the application, and the rest of the frame 400 and other parts of the child stroller are known in the art, so their descriptions are omitted. In the application, a rear wheel will be taken as an example to discuss the parking structure of the child stroller, and it should be understood, such parking structure can also be applied to front wheels.

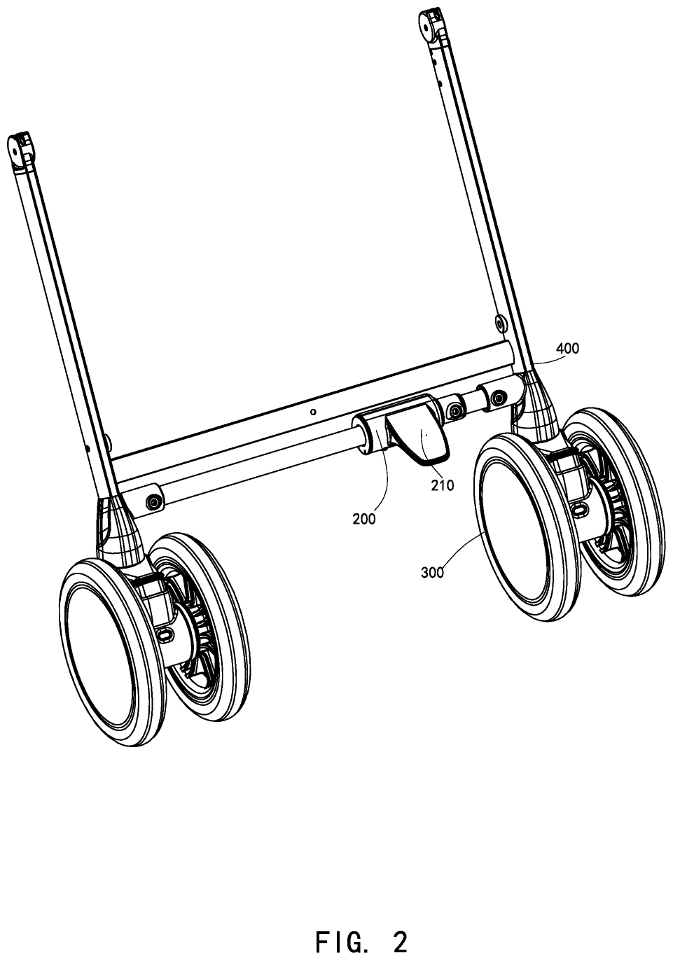

The parking structure includes a locking structure 100 disposed at each of the wheels 300 and a drive structure 200 disposed at the frame 400. The drive structure 200 is connected to the locking structure 100 by a traction member 250, such as a cable, and controls the locking structure 100. The drive structure 200 includes a pedal 210. The pedal 210 is usually in an initial position as shown in FIG. 1 and can be stepped down by a user to reach an active position as shown in FIG. 2 and brings the locking structure 100 to lock the wheels 300 at the same time. When the user releases the pedal 210, the pedal 210 automatically returns to the initial position. Moreover, when the user steps down the pedal 210 again, the pedal 210 brings the locking structure 100 to release the wheels 300. The initial and active positions of the pedal 210 may also be referred to as the initial and active positions of the drive structure 200. The process that the drive structure 200 is driven from the initial position to the active position and then automatically returns to the initial position is referred to as one reciprocating motion of the drive structure. One reciprocating motion of the drive structure 200 causes the locking structure 100 to switch from a released position to a locked position, or from the locked position to the released position. That is, both locking and unlocking operations of the wheels 300 are performed by stepping down the pedal 210 (and releasing the pedal 210 to automatically return), so it is possible to avoid pollution or damage to the user's instep.

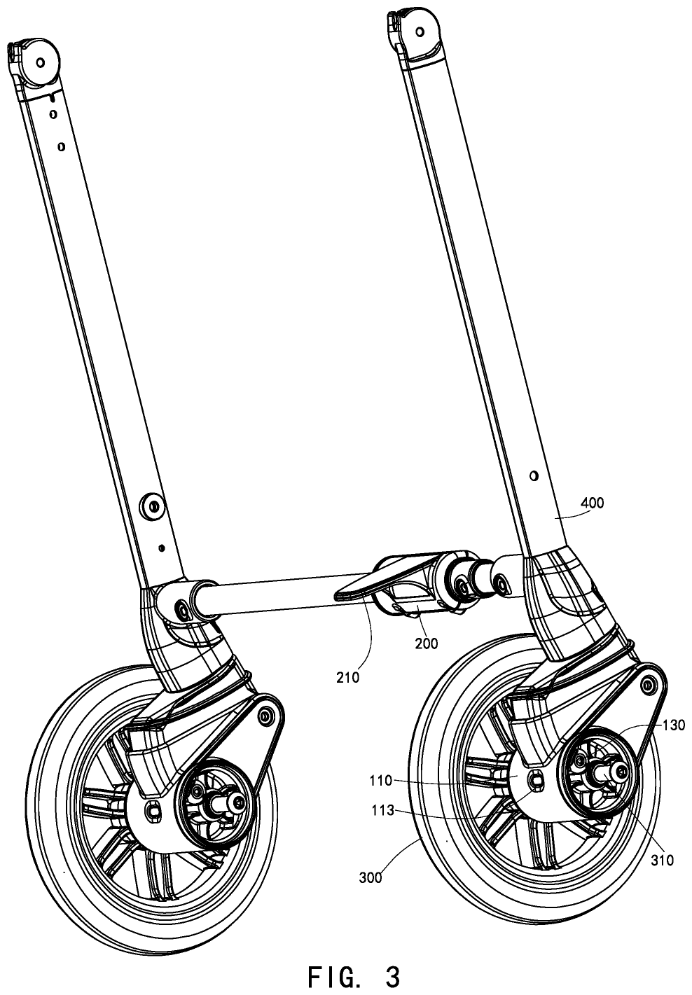

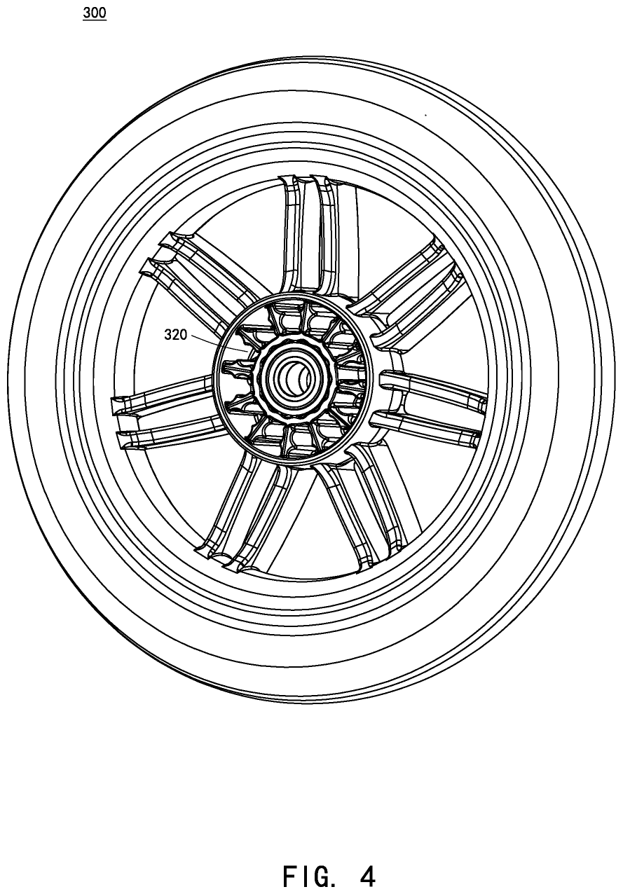

Referring to FIGS. 3 and 4, the principle of locking and releasing the wheel 300 by the locking structure 100 will be described. The locking structure 100 includes a housing 110 mounted below the frame 400, and the wheel 300 is rotatably joined to the housing 110 through an axle 310. A locking pin 130 is disposed in the housing 110, and the locking pin 130 can move in a direction parallel to the axle 310 and be inserted into a slot 320 of the wheel 300 according to operation of the drive structure 200, thus preventing the wheel 300 from rotating.

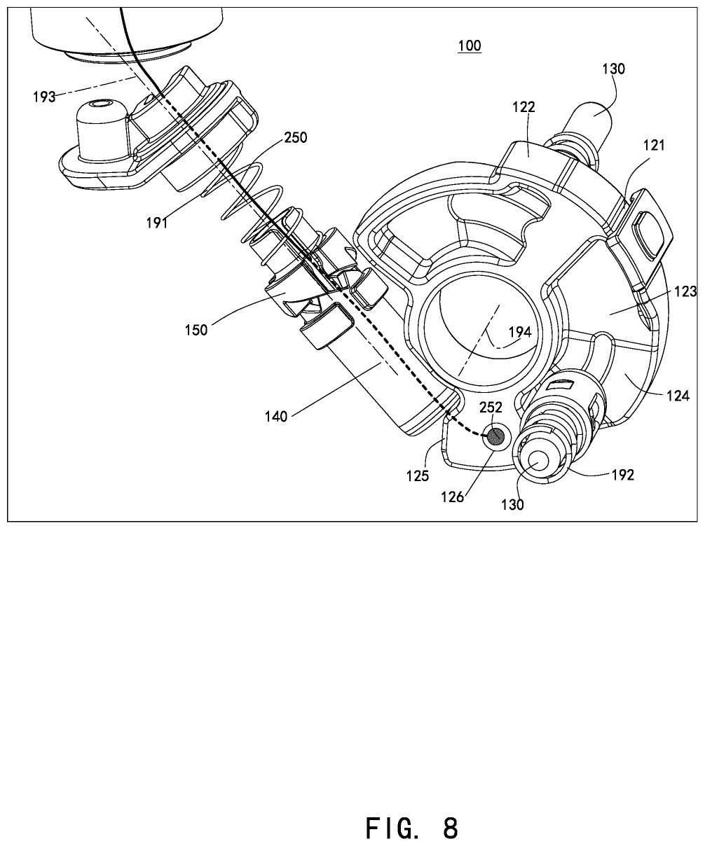

In this embodiment, two wheels 300 are arranged in a set on both sides of the housing 110, so there are two locking pins 130 in the housing 110 (see FIG. 8 for another locking pin 130), and the two locking pins 130 can lock the two wheels 300 respectively. It should be understood, only wheel 300 can be arranged on one side of the housing 110, and only one locking pin 130 is provided correspondingly. It should also be understood, the locking pin 130 can also be replaced by some other locking device, e.g., some other parking device known in the art such as a friction plate and a clamping plier.

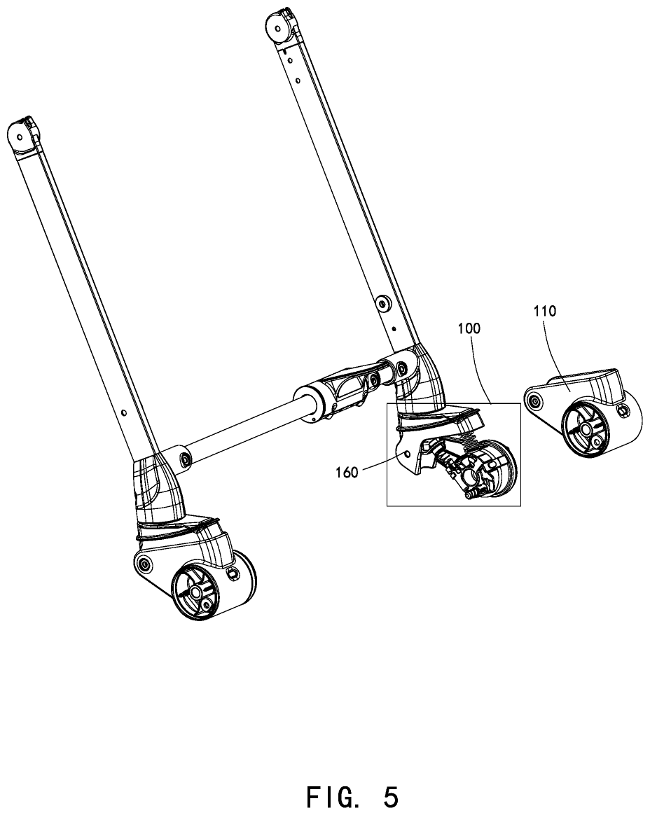

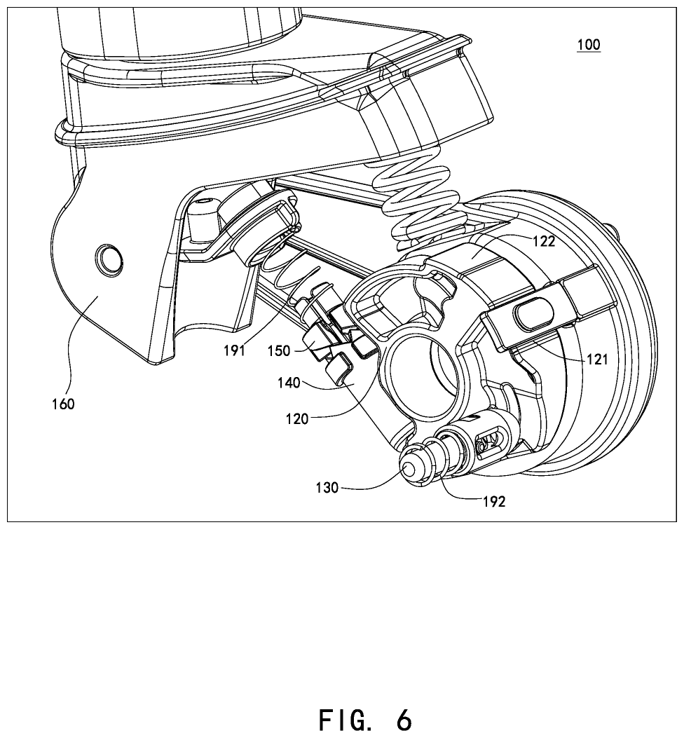

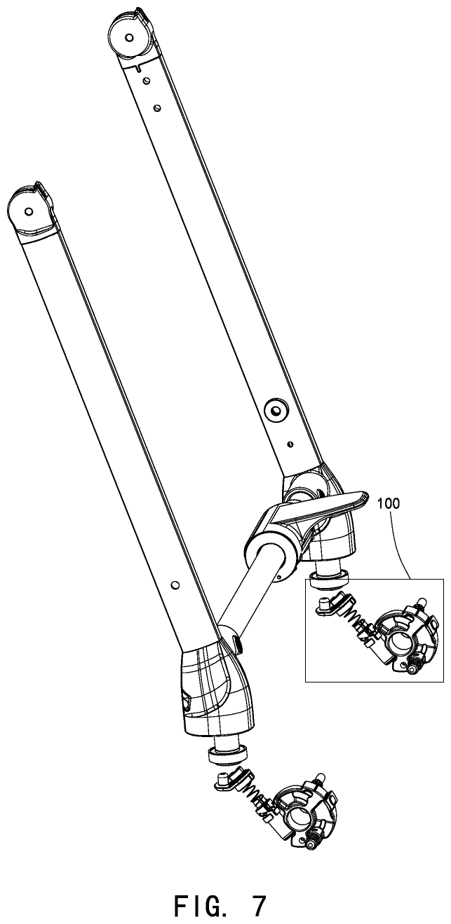

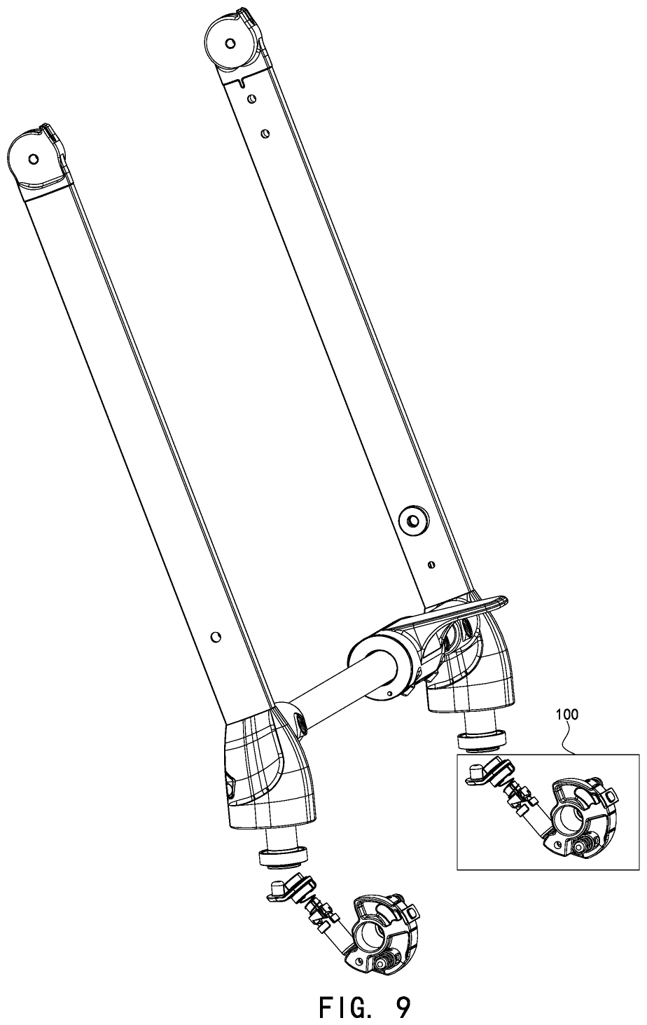

Referring to FIGS. 5 to 10, the locking structure 100 according to the application will be described in detail. The locking structure 100 includes a housing 110, a brake member 120, a locking pin 130, an actuating housing 110, a braking part 120, a locking pin 130, an actuating part 140, and a clamping part 150, and may further include a wheel seat 160, a clamping part elastic member 191, and a locking pin elastic member 192.

The housing 110 is used for accommodating other parts of the locking structure 100 and mounting the wheels 300. The housing 110 may be fixed below the frame 400 through the wheel seat 160, so as to allow the housing 110 to rotate in respect to the frame 400. The housing 110 can also be directly fixed below the frame 400, such that the wheel seat 160 can be omitted.

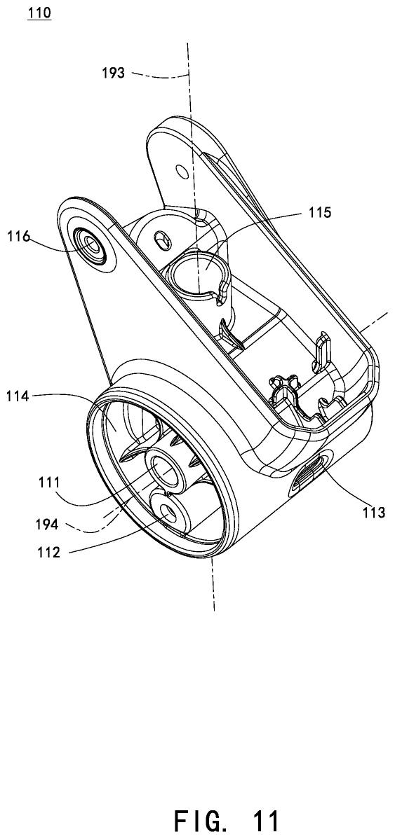

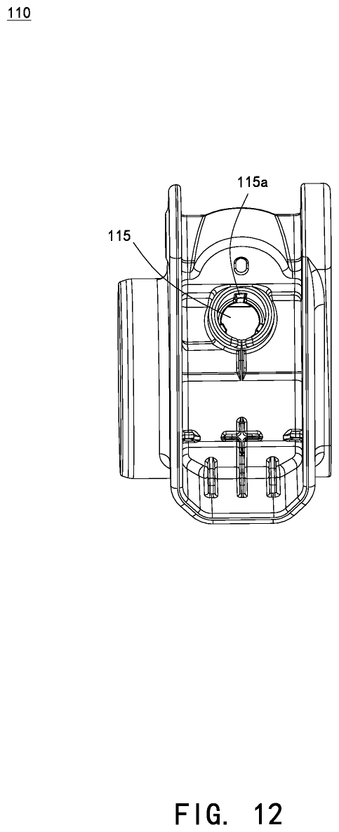

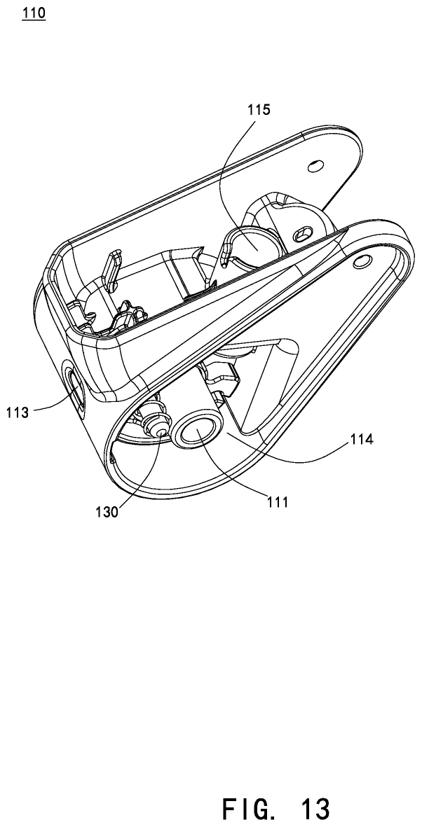

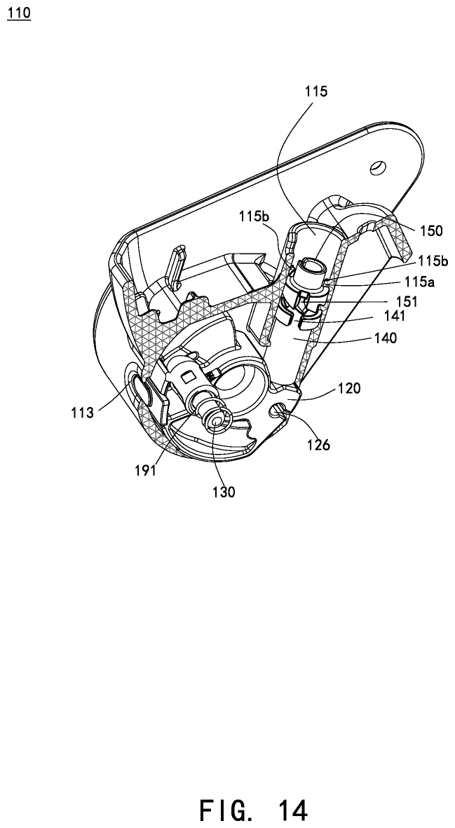

Referring to FIGS. 11 to 14, a specific structure of the housing 110 will be described. The housing 110 includes an axle hole 111, a pin hole 112, an indicator window 113, a receiving cavity 114, an accommodating cavity 115, and a wheel seat joint 116. The axle hole 111 is a hole for accommodating the axle 310. The receiving cavity 114 is arranged around the axle hole 111 for receiving the braking part 120.

The receiving cavity 114 is a substantially cylindrical cavity and is arranged to allow the braking part 120 to rotate within a range. The pin hole 112 is arranged on a side of the axle hole 111 for accommodating the locking pin 130 and allow an axial movement of the locking pin 130. The accommodating cavity 115 is a substantially cylindrical cavity extending in a direction toward the frame 400.

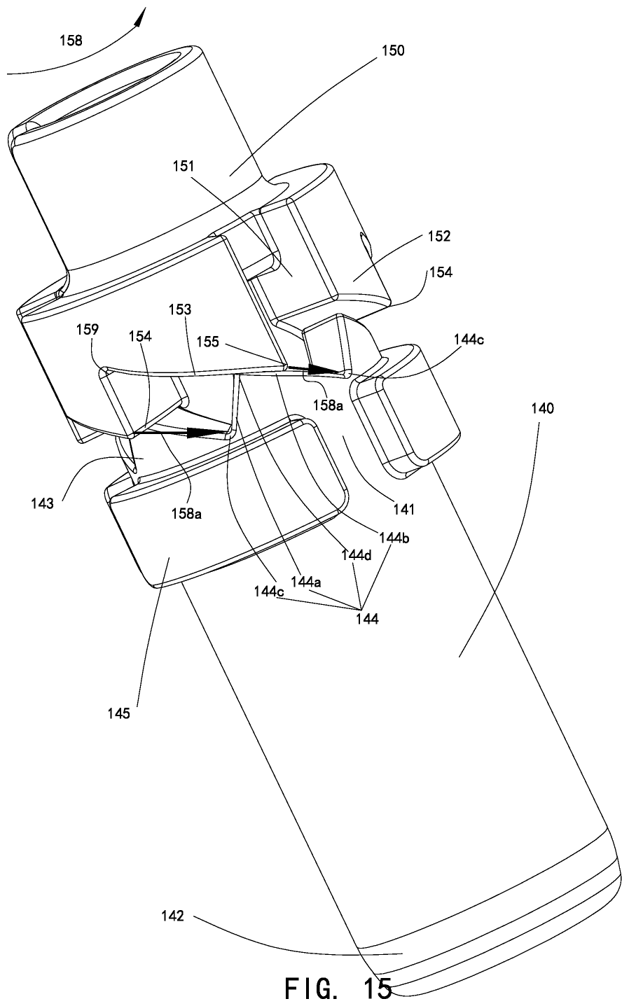

A rib 115a is disposed on an inner wall of the accommodating cavity 115. The rib 115a protrudes inward along the inner wall of the accommodating cavity 115 and extends along a first axis 193 of the locking structure 100. The rib 115a does not extend over the entire axial length of the accommodating cavity 115, but lacks a section at one end close to the frame 400. Thus, the rib 115a is always engaged in an actuating part slot 141 of the actuating part 140, allowing the axial movement of the actuating part 140 and preventing the rotation thereof. As for the clamping part 150, only when the clamping part 150 is in a certain axial position, the rib 115a may prevent the clamping part 150 from rotating, allowing the clamping part 150 in a first rotational position to move to a first axial position and a second axial position, while preventing the clamping part (150) in a second rotational position from moving to the first axial position, which will be described in detail hereinbelow. A top bevel 115b is disposed at a top of the rib 115a. With the rotation and axial movement of the clamping part 150, the top bevel 115b can abut against a first ratchet tooth 152 or a second ratchet tooth 153 of the clamping part 150, so as to push the clamping part 150 to rotate. The clamping part 150 performs axial movement and rotation under action of the actuating part 140 and the rib 115a, thereby moving circularly between a blocked position and an unblocked position, and the clamping part 150 in the blocked position keeps the braking part 120 in the locked position, which will be described in detail in connection with FIGS. 15 to 18.

The wheel seat joint 116 is arranged in the housing 110 at a position close to the frame 400 for joining to the wheel seat 160.

The indicator window 113 is penetratingly arranged on an outer side of the receiving cavity 114, so as to facilitate the user to observe a first indicating portion 121 or a second indicating portion 122 of the braking part 120.

Returning to FIGS. 5 to 10, the braking part 120, the actuating part 140, and the clamping part 150 are all accommodated in the housing 110. The actuating part 140 is defined to reciprocate along the first axis 193, the clamping part 150 is defined to be able to reciprocate along the first axis 193 and rotate around the first axis 193 in a rotation direction 158 (see FIG. 15), and the braking part 120 is defined to rotate around the second axis 194. In this embodiment, the second axis 194 is substantially perpendicular to the first axis 193 and coincides with a rotation axis of the wheel 300. In other embodiments, the first axis 193 and the second axis 194 may be at other angles, and the second axis 194 may not coincide with the rotation axis of the wheel 300.

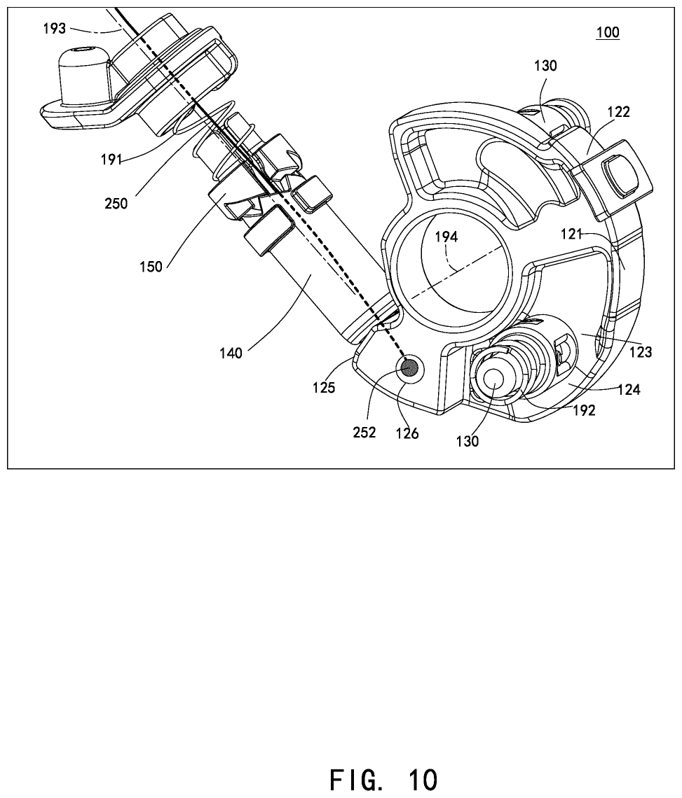

More specifically, the braking part 120 is disposed in the receiving cavity 114 of the housing 110 (see FIGS. 11 to 14) and can rotate around the second axis 194 between the locked position shown in FIG. 10 and the released position shown in FIG. 8. The braking part 120 is at least partially approximately sector-shaped. The braking part 120 includes a raised portion 123, a recessed portion 124, a pressing portion 125, and a traction member second end joining portion 126.

The raised portion 123 rises to one side along the second axis 194 on a sector-shaped disk surface. The recessed portion 124 is adjacent to the raised portion 123 in a circumferential direction and recessed toward the other side opposite to the raised portion 123. The pressing portion 125 is located outside one end of the sector and is arranged to abut against the actuating part 140. The traction member second end joining portion 126 is arranged near the pressing portion 125 to join a traction member second end 252 of the traction member 250. A traction member first end 251 of the traction member 250 is joined to the drive structure 200, which will be described in detail below.

The locking pin 130 can move in the housing 110 along the second axis 194. When the braking part 120 is in the locked position, the locking pin 130 abuts against the raised portion 123 and extends out of the housing 110 to be inserted into a corresponding slot 320 of the wheel 300, so as to lock the wheel 300. When the braking part 120 is in the released position, the locking pin 130 abuts against the recessed portion 124 and retracts into the housing 110 to release the wheel 300. Only the raised portion 123 and the recessed portion 124 on one side of the braking part 120 are shown. It can be imagined that in an embodiment where on both sides of the housing 110 are respectively provided with a wheel 300, both sides of the braking part 120 re respectively provided with a locking pin 130, so both sides of the braking part 120 are correspondingly with a raised portion 123 and the recessed portion 124, respectively.

It should be understood, if the locking pin 130 is replaced by a parking device such as a friction plate, a clamping plier, etc., the form of the braking part 120 can also be changed accordingly, for example, a cam, a lever, etc., and it is only necessary to be able to operate the parking device when being pulled by the traction member 250.

In an embodiment, the braking part 120 further includes a first indicating portion 121 and a second indicating portion 122 respectively located on a sector-shaped outer peripheral surface of the braking part 120. The first indicating portion 121 and the second indicating portion 122 may respectively have different visual effects, for example, the first indicating portion 121 may be green and the second indicating portion 122 may be red. The housing 110 further includes a transparent or hollowed indicator window 113 (see FIGS. 11 to 14) opened at the outer periphery corresponding to the first indicating portion 121 and the second indicating portion 122 of the braking part 120, so as to display one of the first indicating portion 121 and the second indicating portion 122. When the braking part 120 is in the released position, the first indicating portion 121 is located at the indicator window 113, and when the braking part 120 is in the locked position, the second indicating portion 122 is located at the indicator window 113. Thus, the user can easily observe the state of the locking structure 100.

When the braking part 120 is pulled by the traction member 250, the pressing portion 125 of the braking part 120 will move towards the actuating part 140 and push the actuating part 140 to move along the first axis 193. The actuating part 140 in turn pushes the clamping part 150 to move and rotate. Hereinafter, when the braking part 120 is in the released position, the axial positions of the actuating part 140 and the clamping part 150 are referred to as first axial position (the position shown in FIG. 8), at this time, the clamping part 150 is relatively close to the braking part 120, and when the braking part 120 is in the locked position, the axial position of the actuating part 140 and the clamping part 150 are referred to as second axial position (the position shown in FIG. 10), at this time, the clamping part 150 is relatively far away from the braking part 120. For the clamping part 150, the rotational position where the clamping part slot 151 is engaged to the rib 115a is referred to as first rotational position, and rotational position where the clamping part slot 151 is disengaged from the rib 115a and a ratchet portion 156 of the clamping part 150 (described in detail below) abuts against an end face of the rib 115a is referred to as second rotational position.

The clamping part elastic member 191 is disposed between the clamping part 150 and the housing 110 or the wheel seat 160 connected to the housing 110 and biases the clamping part 150 to the first axial position. The locking pin elastic member 192 is disposed between the locking pin 130 and the housing 110 and biases the locking pin 130 to be retracted into the housing 110.

Referring to FIGS. 15 to 17, specific structures of the actuating part 140 and the clamping part 150 will be described. The clamping part 150 includes a plurality of ratchet portions 156, a clamping part slot 151, and a through slot 157.

The ratchet portions 156 protrude toward the actuating part 140 at an end of the clamping part 150 facing the actuating part 140 and are arranged at intervals along the circumferential direction of the clamping part 150. Each of the ratchet portions 156 includes a first ratchet tooth 152 and a second ratchet tooth 153 arranged in sequence along the rotation direction 158.

The clamping part slot 151 is disposed between adjacent ratchet portions 156 and extends along the first axis 193, corresponding to the rib 115a of the housing 110. When the clamping part 150 is in the first rotational position, the clamping part slot 151 is engaged with the rib 115a, and at this time, the rib 115a does not hinder the axial movement of the clamping part 150, allowing the clamping part 150 to move between the first axial position and the second axial position. When the clamping part 150 is in the second rotational position (the clamping part 150 needs to firstly arrive at the second axial position or a third axial position which will be described below, then can be separated away from rotating lock of the rib 115a and rotated to the second rotational position), the rib 115a is no longer engaged with the clamping part slot 151, but abuts against a ratchet slot 159, more specifically, the top bevel 115b of the rib 115a abuts against the ratchet slot 159 to prevent the clamping part 150 from axially moving back to the first axial position. Therefore, the housing 110 allows the clamping part 150 in the first rotational position to move to the first axial position and the second axial position, while preventing the clamping part 150 in the second rotational position (i.e., the blocked position) from moving to the first axial position.

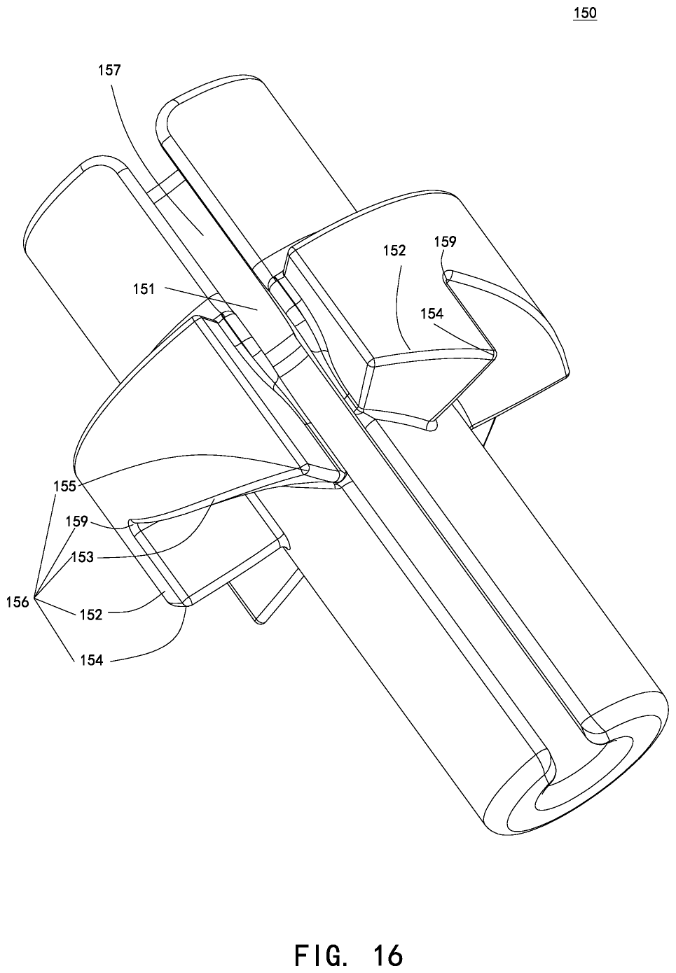

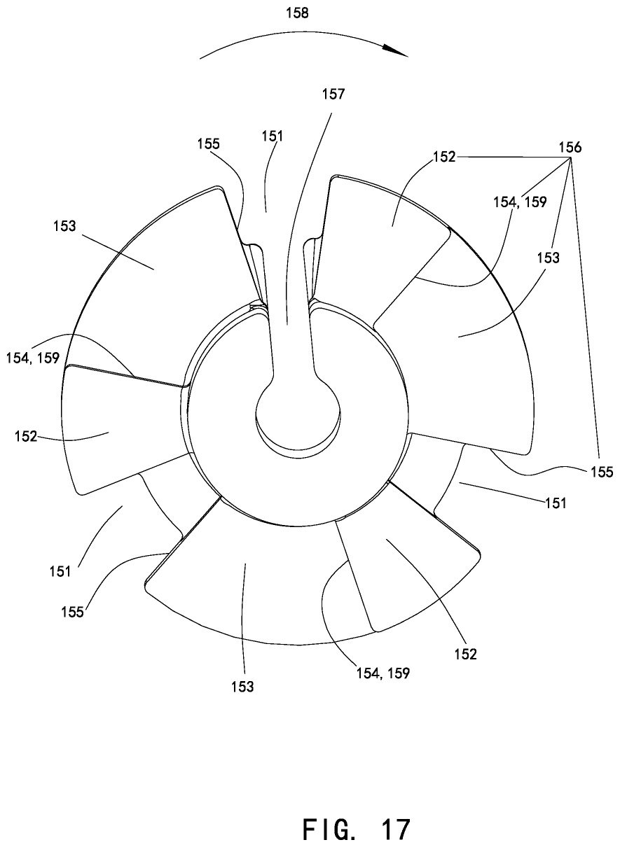

Referring to FIGS. 16 to 17, the through slot 157 is disposed at one of the clamping part slots 151 and penetrates a side wall of the clamping part 150, so as to facilitate inserting the traction member 250 into the clamping part 150.

More specifically, the clamping part 150 has a cylindrical shape around the first axis 193, and a plurality of the ratchet portions 156 are arranged at intervals along the circumferential direction of the clamping part 150, and each of the first ratchet teeth 152 and each of the second ratchet teeth 153 has a ratchet tooth face extending radially. The ratchet tooth faces of the first ratchet teeth 152 and the second ratchet teeth 153 are all inclined in the same direction in respect to the first axis 193. The stroke of the ratchet tooth face of each first ratchet tooth 152 in the circumferential direction is smaller than that of the ratchet tooth face of each second ratchet tooth 153 in the circumferential direction, and a front end of each of the ratchet tooth faces in the rotation direction 158 is closer to the actuating part 140 (see FIG. 15), while a rear end in the rotation direction 158 is further away from the actuating part 140.

The ratchet portions 156 further includes first peaks 154 formed at the front ends of the first ratchet teeth 152 and second peaks 155 formed at the front ends of the second ratchet teeth 153. The first peaks 154 and the second peaks 155 are basically located on the same cross section in respect to the first axis 193, in other words, the first peaks 154 and the second peaks 155 are located at the same axial position along the first axis 193. A ratchet slot 159 is also formed at the rear end of each of the second ratchet teeth 153. The ratchet slots 159 and the first peaks 154 are connected by axially extending surfaces, so if viewed in the axial direction (FIG. 17), the ratchet slots 159 and the first peaks 154 are approximately at the same position.

In this embodiment, three ratchet portions 156 are provided, and it should be understood, in other embodiments, more or less ratchet portions 156 may be provided.

The actuating part 140 includes an actuating part first end 142, an actuating part second end 143, a plurality of actuating teeth 144, and may further include an actuating part slot 141 and an actuating part flange 145.

The actuating part first end 142 abuts against the pressing portion 125 of the braking part 120. The actuating part second end 143 is opposite to the actuating part first end 142 along the first axis 193. The plurality of actuating teeth 144 are arranged on the actuating part second end 143 at intervals in the circumferential direction, protrude toward the clamping part 150, and can abut against the first ratchet teeth 152 and the second ratchet teeth 153 of the clamping part 150.

More specifically, for each portion of the actuating part 140 corresponding to the first ratchet teeth 152 and the second ratchet teeth 153, there is one actuating tooth 144 arranged. A tooth face of each actuating tooth 144 includes a first bevel 144a and a second bevel 144b connected to each other. The first bevel 144a is located at the rear along the rotation direction 158 and has a relatively large slope and a relative small circumferential stroke, and the second bevel 144b is located at the front along the rotation direction 158 and has a relative small slope and a relative large circumferential stroke.

The tooth faces of the actuating teeth 144 and the ratchet tooth faces of the first ratchet teeth 152 and the second ratchet teeth 153 abut against each other, and a radial dimension of an outer circumference of each of the actuating teeth 144 is smaller than a radial dimension of an inner circumference of the rib 115a, that is, the actuating teeth 144 are located on a radial inner side of the rib 115a, such that when the actuating part 140 moves axially in respect to the housing 110, the actuating teeth 144 and the rib 115a will not interfere with each other. Thus, the actuating teeth 144 may abut against a radially inner portion of the ratchet portions 156, and the rib 115a may abut against a radially outer portion of the ratchet portions 156.

The actuating part 140 may have a substantially cylindrical shape. The actuating part flange 145 is disposed close to an enlarged diameter portion of the actuating part second end 143. The actuating part slot 141 is arranged, accordingly with the clamping part slot 151, at the actuating part flange 145, so as to be engaged to the rib 115a, thereby limiting the movement of the actuating part 140 along the first axis.

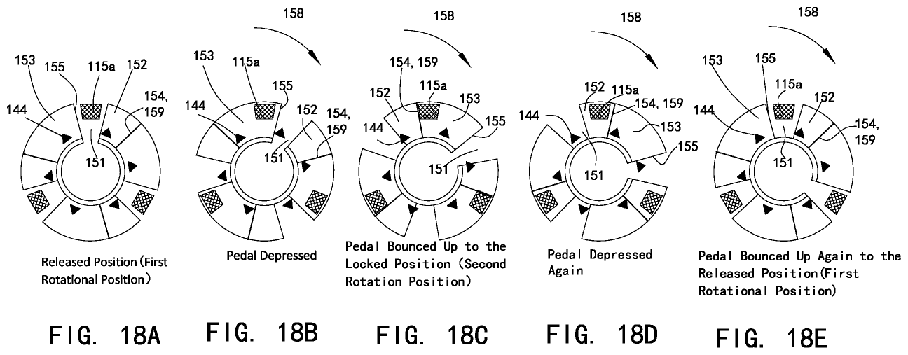

Referring to FIGS. 18A to 18E in conjunction with FIGS. 15 to 17, the relative motions among the housing 110 (the rib 115a), the actuating part 140, and the clamping part 150 will be described. The figure schematically shows the positions of the above parts, which does not represent the specific shapes thereof.

In FIG. 18A, the locking structure 100 is in the released position, and at this 10 time, the clamping part 150 is in the unblocked position, i.e., in the first axial position and the first rotational position.

Starting from the state shown in FIG. 18A, when the user steps down the pedal 210, the locking structure 100 reaches the state shown in FIG. 18B. During this process, the traction member 250 pulls the braking part 120, and the actuating part 140 and the clamping part 150 start to move towards the frame 400 under pushing of the braking part 120. When the pedal 210 is stepped to the active position, the clamping part 150 is in a transition position between the blocked position and the unblocked position, that is, the clamping part 150 reaches a third axial position that is closer to the frame 400 than the second axial position. Meanwhile, if the pedal 210 is continuously stepped, the clamping part slot 151 will be separated from the rotation restriction of the rib 115a on the clamping part 150, and the clamping part slot 151 will be separated from the range of the rib 115a, accordingly, the clamping part 150 will rotates in the rotation direction 158 shown in the figures due to the interaction between the ratchet portion 156 (the first ratchet tooth 152 and the second ratchet tooth 153) and the actuating teeth 144, until the first peak 154 and the second peak 155 are clamped at grooves 144c of the actuating teeth 144 in the direction shown by the arrow 158a in FIG. 15.

Thereafter, when the user releases the pedal 210, the locking structure 100 reaches the state shown in FIG. 18C. During the process of the locking structure 100 from FIG. 18B to FIG. 18C, the actuating part 140 no longer abuts against the clamping part 150, and the clamping part 150 is biased toward the wheels 300 by the clamping part elastic member 191. Because the clamping part 150 has deviated from the first rotational position, the top bevel 115b of the rib 115a abuts at the ratchet tooth face of one of the second ratchet teeth 153, thus exerting a thrust in the rotation direction 158 to the clamping part 150, so the clamping part 150 continues to rotate in the rotation direction 158 until the rib 115a is clamped at one of the ratchet slots 159. At this time, the clamping part 150 is stopped in the blocked position, that is, the second rotational position and the second axial position, and the braking part 120 is stopped in the locked position (described in detail below).

Thereafter, the user steps down the pedal 210 again, the locking structure 100 finally reaches the state shown in FIG. 18D. During the process of the locking structure 100 from FIG. 18C to FIG. 18D, the actuating part 140 abuts against the clamping part 150 again. Since the state of the clamping part 150 in FIG. 18C has been rotated an angle compared with its state in FIG. 18B, the actuating part 140 can continue to push the clamping part 150 to rotate in the rotation direction 158 until the first peak 154 and the second peak 155 are clamped at the grooves 144c of the actuating teeth 144.

Thereafter, the user releases the pedal 210 again, and the locking structure 100 finally reaches the state shown in FIG. 18E. During the process of the locking structure 100 from FIG. 18D to FIG. 18E, the actuating part 140 no longer abuts against the clamping part 150, and the clamping part 150 is biased toward the wheel 300 by the clamping part elastic member 191. The top bevel 115b of the rib 115a abuts against the ratchet tooth face of one of the first ratchet teeth 152, thereby exerting a thrust in the rotation direction 158 to the clamping part 150, so the clamping part 150 continues to rotate in the rotation direction 158 until the rib 115a is clamped in the clamping part slot 151. At this time, the clamping part 150 is in the first rotational position again, that is, the clamping part slot 151 is in the position corresponding to the rib 115a again, so the clamping part 150 can return to the first axial position. That is, the clamping part 150 in FIG. 18E is in the unblocked position, and the state in FIG. 18E is corresponding to the state in FIG. 18A (but the clamping part 150 rotates by an angle of one ratchet portion 156), the locking structure 100 completes an action cycle.

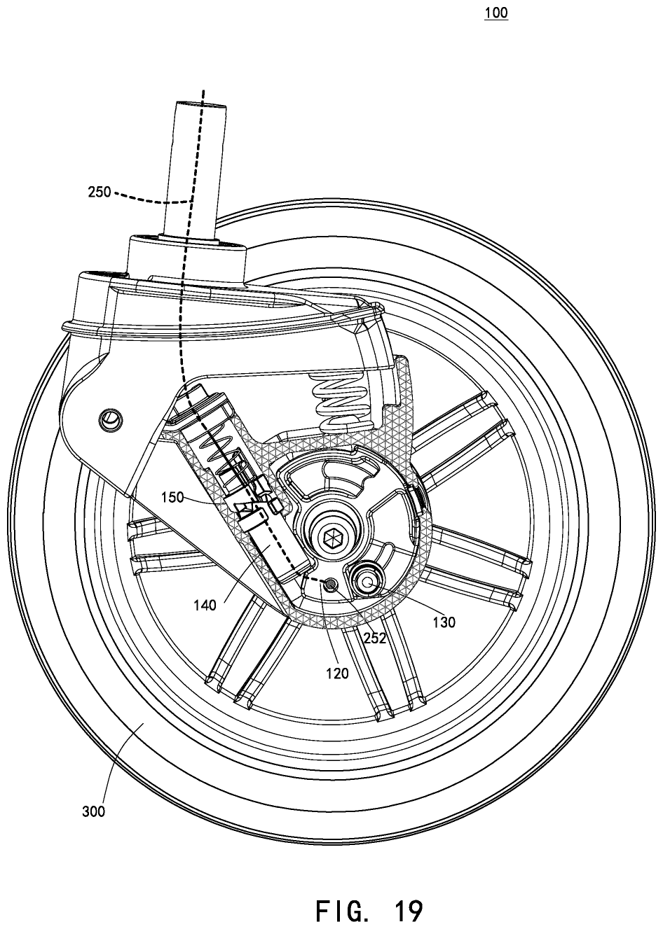

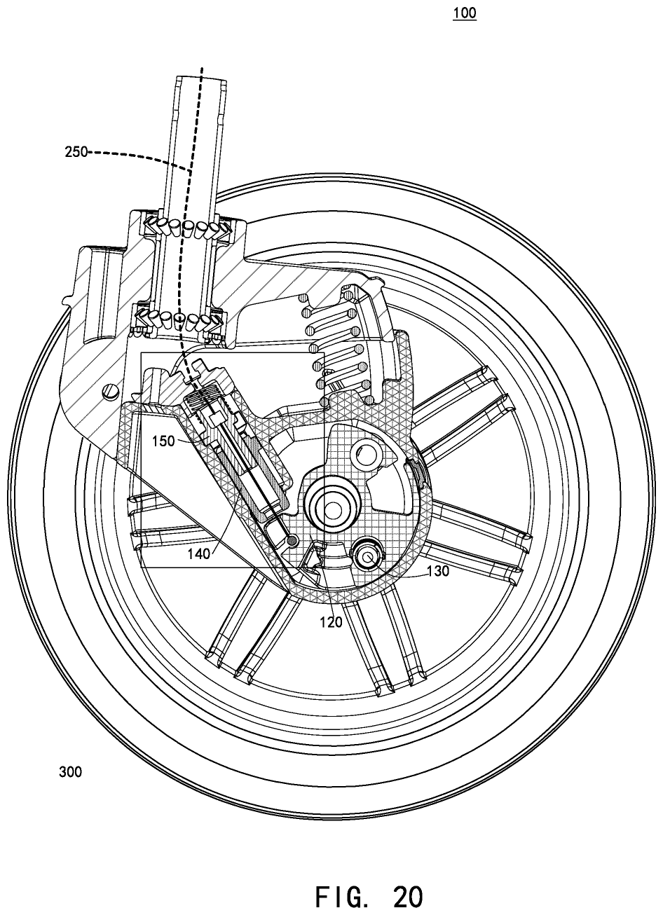

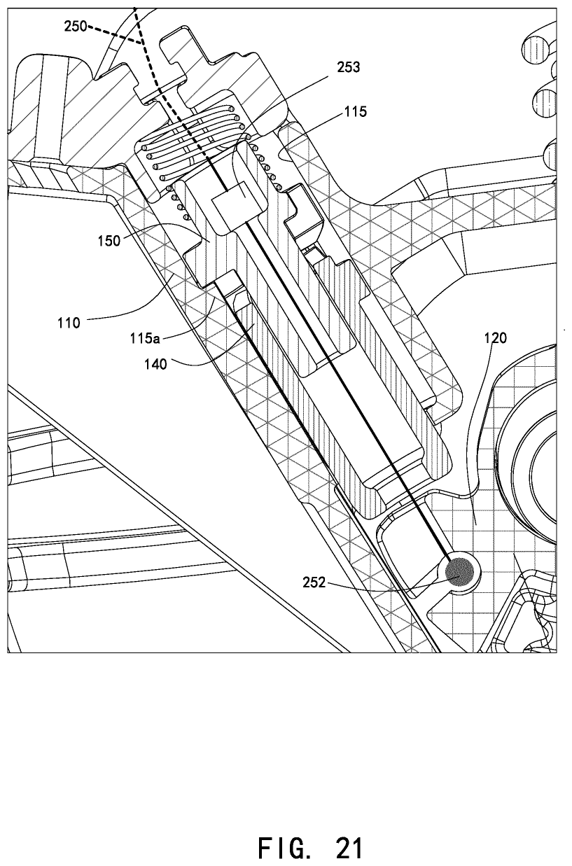

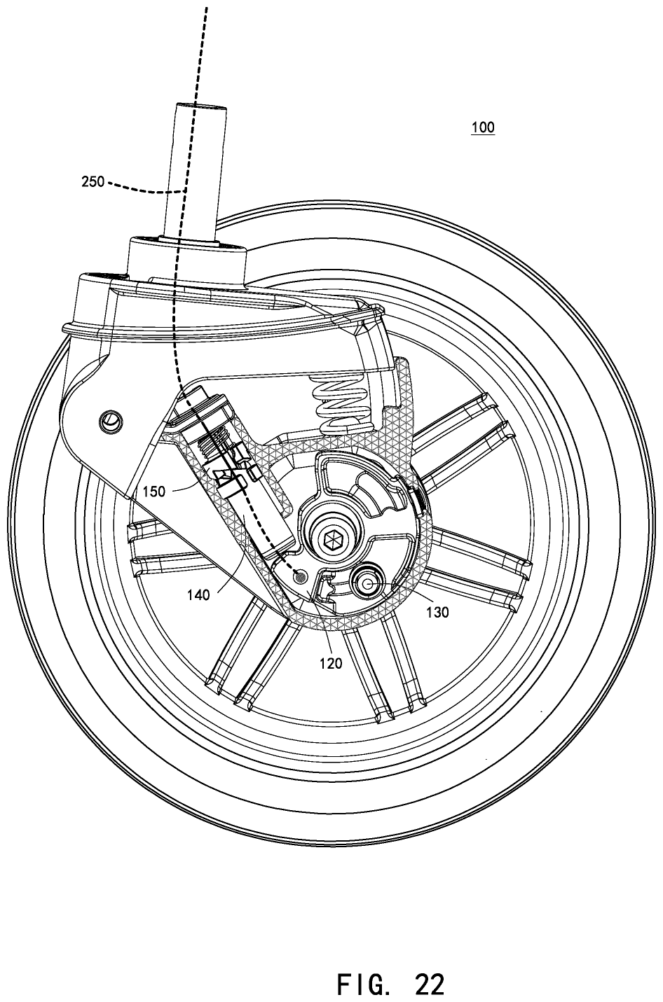

Referring to FIGS. 19 to 22, the operation process of the locking structure 100 can be better understood. In particular, as shown in FIGS. 20 and 21, the traction member 250 is provided with a traction member engagement portion 253, and the traction member engagement portion 253 is engaged in the clamping part 150. Thus, when the clamping part 150 is in the second axial position (i.e., the blocked position), the clamping part 150 pulls the traction member 250 through the traction member engagement portion 253, and the traction member 250 pulls the traction member second end joining portion 126 of the braking part 120 through the traction member second end 252 in turn, so as to prevent the braking part 120 from returning to the released position, thereby achieving the parking function.

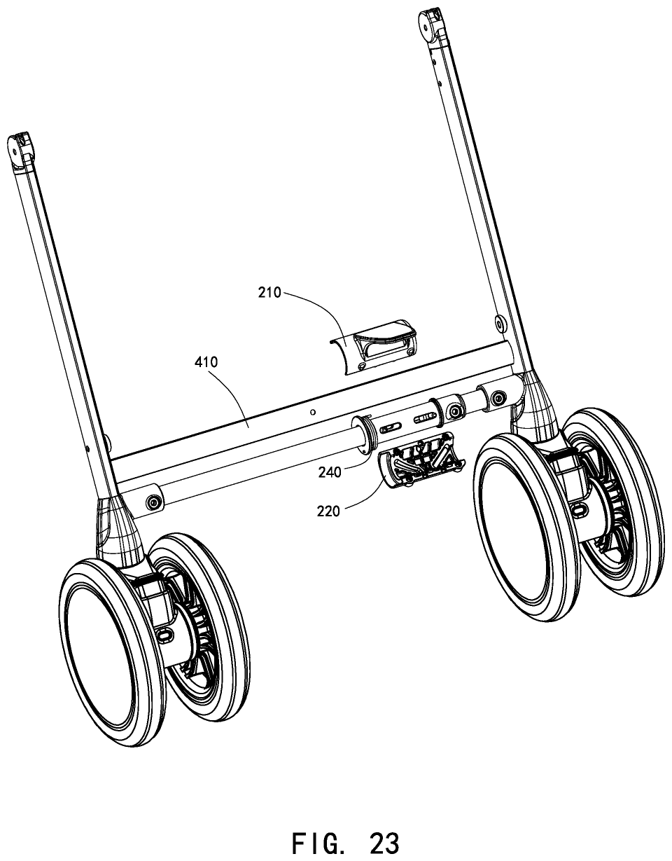

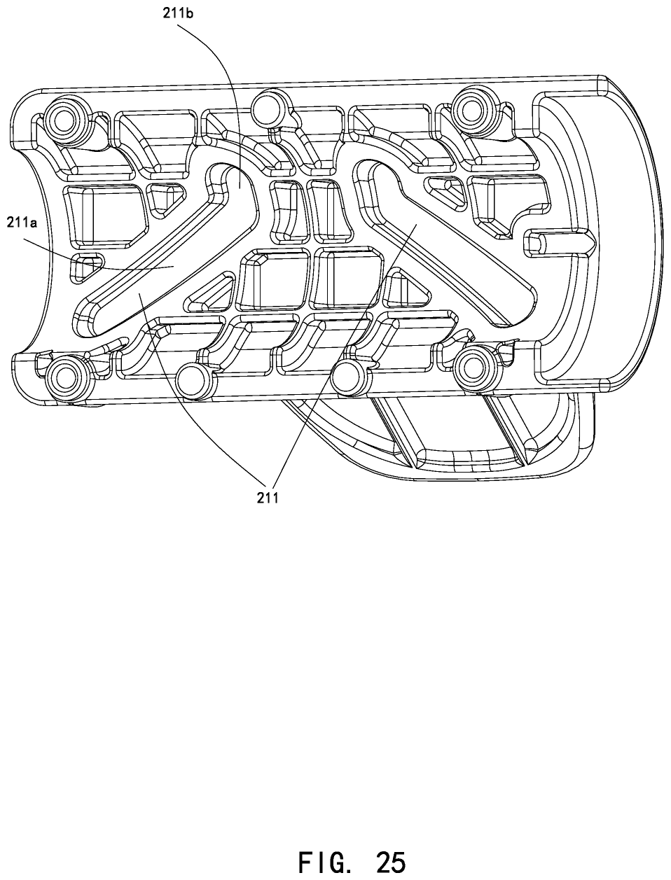

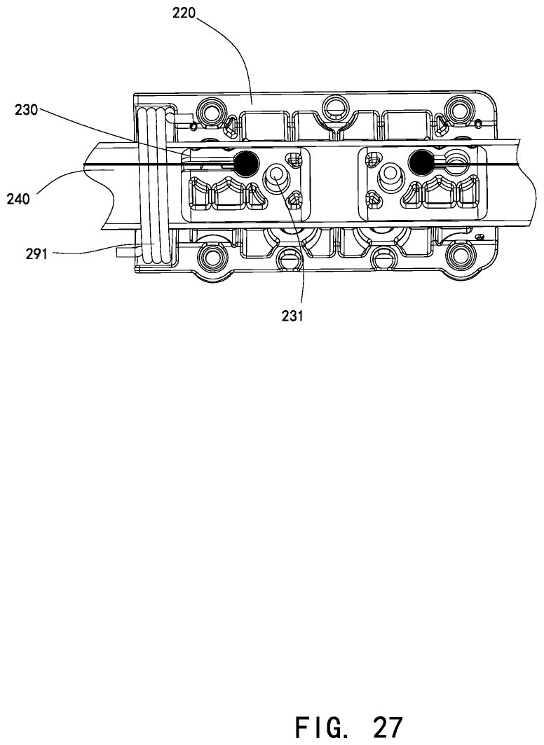

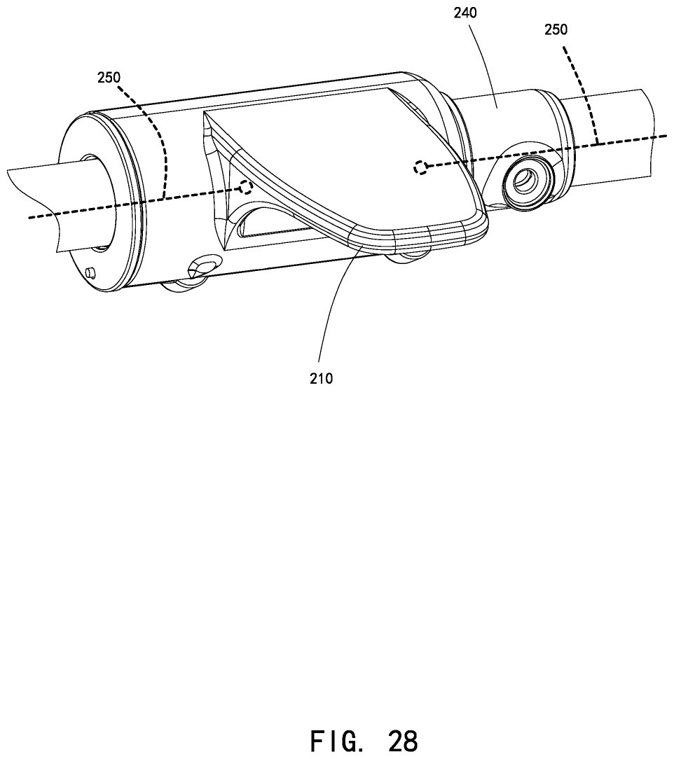

Referring to FIGS. 23 to 29, the drive structure 200 will be described in detail. The drive structure 200 includes a sleeve 240, a pedal 210, a slider 230, and may further include an abutting member 220 and a pedal elastic member 291.

The sleeve 240 is arranged in a lateral direction on a crossbeam 410 of the frame 400 connected to the wheel 300 for accommodating other parts of the drive structure 200.

The pedal 210 is sleeved outside the sleeve 240 and can be stepped to rotate around the sleeve 240. A pedal channel 211 is arranged on an inner wall of the pedal 210, and the pedal channel 211 includes a slanted portion 211a extending obliquely in the lateral direction. In an embodiment, a vertical portion 211b extending perpendicular to the lateral direction may also extend from an end of the slanted portion 211a far away from the wheel, so as to keep pulling the traction member 250.

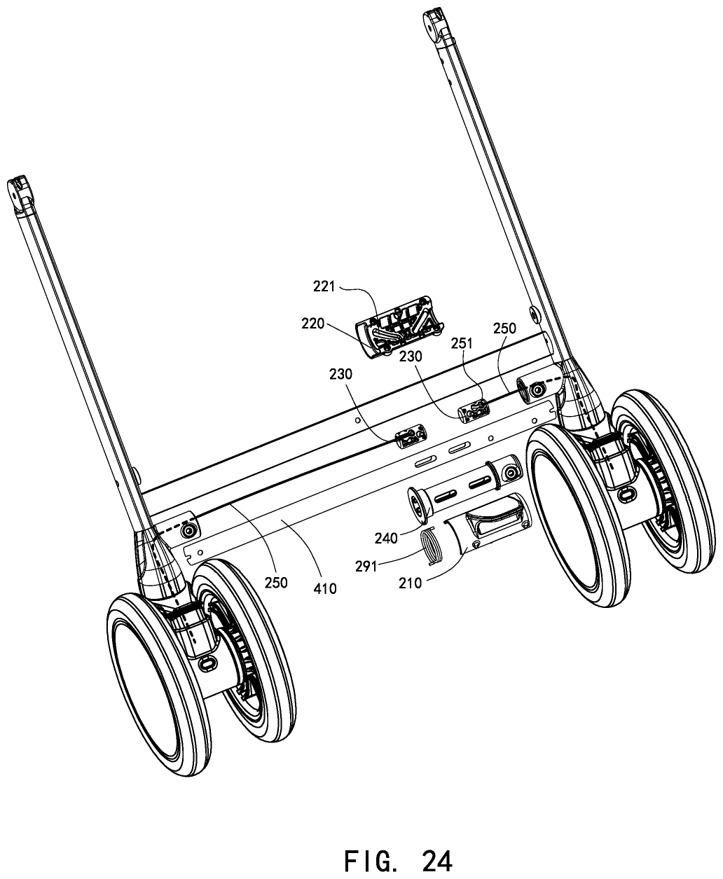

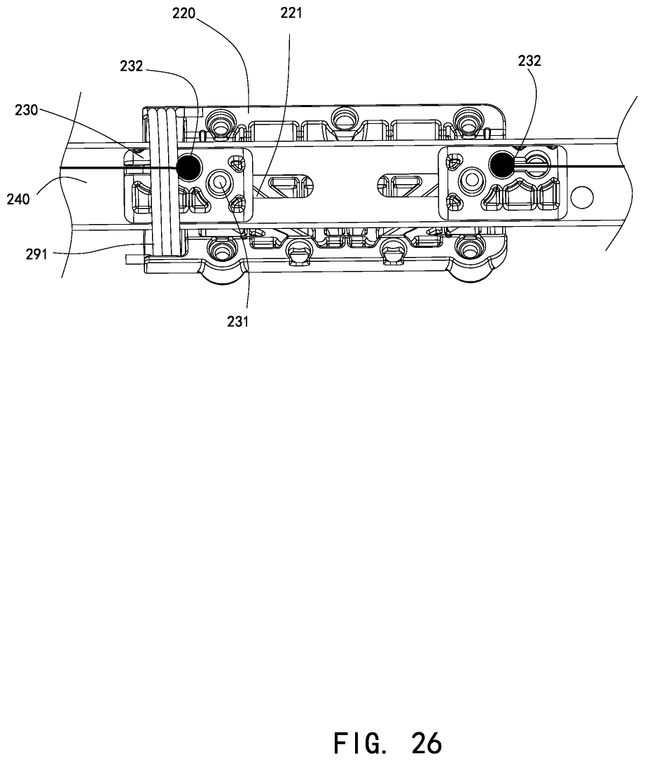

The abutting member 220 and the pedal 210 are respectively formed into semi-cylindrical bodies, such that they can be abutted with each other to form a tubular structure and sleeved outside the sleeve 240 together. As shown in FIGS. 24 and 26, an abutting member channel 221 is disposed on an inner side of the abutting member 220, and the abutting member channel 221 extends obliquely in a direction opposite to the pedal channel 211.

The slider 230 is disposed slidably along the lateral direction in the sleeve 240, and a slider pin 231 is inserted into the slider 230. The extending direction of the slider pin 231 is substantively perpendicular to the lateral direction, and both ends of the slider pin 231 are respectively inserted into the pedal channel 211 and the abutting member channel 221 and can move relatively in the pedal channel 211 and the abutting member channel 221. The traction member 250 is joined to the slider 230 through the interior of the sleeve 240, and the traction member first end 251 is connected to the traction member first end joining portion 232 of the slider 230, so the traction member 250 can be pulled by the slider 230.

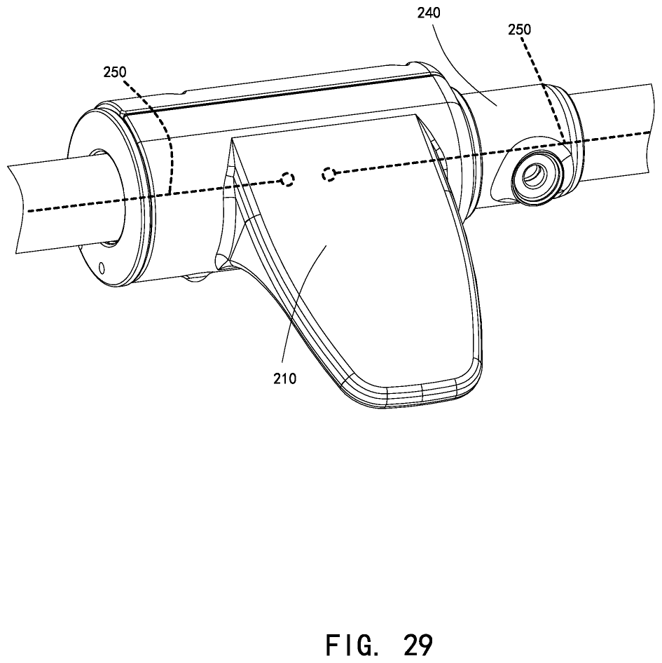

When the pedal 210 is stepped, interaction between the slider pin 231 and the pedal channel 211 and interaction between the slider pin 231 and the abutting member channel 221 respectively urge both ends of the slider pin 231 to move toward the center of the sleeve 240, as shown in FIG. 29. Thus, it is ensured that the extending direction of the slider pin 231 is perpendicular to the sliding direction (lateral direction) and will not rotate, and the smooth movement of the slider pin 231 is also ensured. Therefore, the slider 230 pulls the traction member 250 toward the center of the sleeve 240.

The pedal elastic member 291 is disposed between the pedal 210 and the sleeve 240 for biasing the pedal 210 to the bounced position (initial position).

It should be understood, according to the requirements in use, the drive structure 200 can also be replaced by a handle and other devices, as long as the traction member 250 can be pulled according to operation of the user.

Since the application can be embodied in various forms without departing from the spirit and essence of the application, it should be understood, the above embodiments are not limited to any of the foregoing details, but should be interpreted as broadly as possible within the scope defined by the claims, and therefore all changes that fall within the scope of the claims or their equivalents should be covered by the claims.

### LIST OF REFERENCE SIGNS

100 Locking structre
110 Housing
111 Axle hole
112 Pin hole
113 Indicator window
114 Receiving cavity
115 Accommodating cavity
115a Rib
115b Top bevel
116 Wheel seat joint
120 Braking part
121 First indicating portion
122 Second indicating portion
123 Raised portion
124 Recessed portion
125 Pressing portion
126 Traction member second end joining portion
130 Locking pin
140 Actuating part
141 Actuating part slot
142 Actuating part first end
143 Actuating part second end
144 Actuating tooth
144a First bevel
144b Second bevel
144c Groove
144d Top
145 Actuating part flange
150 Clamping part
151 Clamping part slot
152 First ratchet tooth
153 Second ratchet tooth
154 First peak
155 Second peak
156 Ratchet portion
157 Through slot
158 Rotation direction
158a Engaging direction
159 Ratchet slot
160 Wheel seat
191 Clamping part elastic member
192 Locking pin elastic member
193 First axis
194 Second axis
200 Drive structure
210 Pedal
211 Pedal channel
211a Slanted portion
211b Vertical portion
220 Abutting member
221 Abutting member channel
230 Slider
231 Slider pin
232 Traction member first end joining portion
240 Sleeve
250 Traction member
251 Traction member first end
252 Traction member second end
253 Traction member engagement portion
291 Pedal elastic member
300 Wheel
310 Axle
320 Slot
400 Frame
410 Crossbeam

1. A parking structure comprising:
a locking structure, capable of switching between a locked position that prevents a wheel from rotating and a released position that allows the wheel to rotate; and
a drive structure, connected to the locking structure;
wherein the drive structure is capable of being driven from an initial position to an active position, and automatically returning from the active position to the initial position, so as to perform a reciprocating motion, and one reciprocating motion of the drive structure causes the locking structure to switch from the released position to the locked position or from the locked position to the released position.

2. The parking structure according to claim 1, wherein:
the locking structure includes:
a braking part, connected to the drive structure, capable of being brought by the drive structure to move between a locked position and a released position, so as to lock or release the wheel; and
a clamping part, capable of moving between a blocked position and an unblocked position, and the clamping part in the blocked position keeps the braking part in the locked position.

3. The parking structure according to claim 2, wherein:
the locking structure further includes:
an actuating part, joined to the braking part and the clamping part, during a process of the braking part moving from the released position to the locked position, the actuating part brings the clamping part to the blocked position, and during a process of the braking part moving from the locked position to the released position, the actuating part brings the clamping part to the unblocked position.

4. The parking structure according to claim 3, wherein:
the clamping part is disposed in an accommodating cavity of a housing, and capable of reciprocating along a first axis between a first axial position close to the braking part and a second axial position far away from the braking part and rotating around the first axis along a rotation direction, thereby switching between the first rotational position and the second rotational position;
the accommodating cavity of the housing is configured to allow the clamping part in the first rotational position to move to the first axial position and the second axial position, and to prevent the clamping part in the second rotational position from moving to the first axial position; and
the actuating part is disposed between the braking part and the clamping part, and capable of abutting against the clamping part to make the clamping part rotate along the rotation direction and move towards the second axial position.

5. The parking structure according to claim 4, wherein:
the clamping part includes:
a plurality of ratchet portions, protruding toward the actuating part at an end of the clamping part facing the actuating part, and arranged at intervals along a circumferential direction of the clamping part, each of the ratchet portions includes a first ratchet tooth and a second ratchet tooth arranged in sequence along the rotation direction; and
a clamping part slot, disposed between adjacent ratchet portions and extends along the first axis;
wherein a rib corresponding to a position of the clamping part slot is disposed on an inner wall of the accommodating cavity, and the rib extends along the first axis, such that:
when the clamping part is in the first rotational position, the clamping part slot is engaged to the rib, and when the clamping part is in the second rotational position, the clamping part slot is separated from the rib and one of the second ratchet teeth abuts against an end face of the rib.

6. The parking structure according to claim 5, wherein:
the clamping part has a cylindrical shape around the first axis, each of the first ratchet teeth and each of the f second ratchet teeth has a ratchet tooth face extending radially;
the ratchet tooth faces of the first ratchet teeth and the second ratchet teeth are all inclined in a same direction in respect to the first axis, strokes of the ratchet tooth faces of the first ratchet teeth in the circumferential direction are smaller than strokes of the ratchet tooth faces of the second ratchet teeth in the circumferential direction, and a front end of each of the ratchet tooth faces in the rotation direction is closer to the actuating part, while a rear end in the rotation direction is further away from the actuating part.

7. The parking structure according to claim 5, wherein:
the ratchet portions further includes:
first peaks formed at the front ends of the first ratchet teeth;
second peaks formed at the front ends of the second ratchet teeth; and
the first peaks and the second peaks are basically located on a same cross section in respect to the first axis.

8. The parking structure according to claim 5, wherein:
the actuating part includes:
an actuating part first end, abutting against a pressing portion of the braking part;
an actuating part second end, opposite to the actuating part first end along the first axis; and
a plurality of actuating teeth, arranged on the actuating part second end at intervals in the circumferential direction, protruding toward the clamping part, and capable of abutting against the first ratchet teeth and the second ratchet teeth of the clamping part.

9. The parking structure according to claim 8, wherein:
in the actuating part, for each portion of the first ratchet teeth and the second ratchet teeth, there is one of the actuating teeth correspondingly arranged; and
the tooth face of each of the actuating teeth includes a first bevel and a second bevel connected to each other, the first bevel is located at the rear along the rotation direction and has a relative large slope and a relative small circumferential stroke, the second bevel is located at the front along the rotation direction and has a relative small slope and a relative large circumferential stroke.

10. The parking structure according to claim 8, wherein:
the tooth faces of the plurality of actuating teeth and the ratchet tooth faces of the first ratchet teeth and the second ratchet teeth abut against each other.

11. The parking structure according to claim 8, wherein:
a radial dimension of an outer circumference of each of the plurality of actuating teeth is smaller than a radial dimension of an inner circumference of the rib.

12. The parking structure according to claim 8, characterized in wherein:
the actuating part has a substantially cylindrical shape, and further includes:
an actuating part flange, disposed close to an enlarged diameter portion of the actuating part second end; and
an actuating part slot, arranged, accordingly with the clamping part slot, at the actuating part flange, so as to be engaged to the rib, thereby limiting movement of the actuating part along the first axis.

13. The parking structure according to claim 4, wherein:
the braking part is disposed in a receiving cavity of the housing, capable of rotating around a second axis between the locked position and the released position, at least partially approximately sector-shaped, and includes:
a raised portion, rising to one side along the second axis on a sector shaped disk surface;
a recessed portion, adjacent to the raised portion in a circumferential direction, and recessed toward the other side opposite to the raised portion;
a pressing portion, located outside one end of the sector, and arranged to abut against the actuating part; and
a traction member second end joining portion, arranged near the pressing portion to join a traction member second end of a traction member, and a traction member first end of the traction member is joined to the drive structure, such that the braking part is capable of being pulled by the traction member to move between the locked position and the released position; and
the locking structure further includes a locking pin, and the locking pin is arranged to be capable of moving in the housing along the second axis; and
when the braking part is in the locked position, the locking pin abuts against the raised portion and extends out of the housing to be inserted into a corresponding slot of the wheel, so as to lock the wheel, and when the braking part is in the released position, the locking pin abuts against the recessed portion and retracts into the housing to release the wheel.

14. The parking structure according to claim 4, wherein:
the braking part further includes a first indicating portion and a second indicating portion respectively located on a sector-shaped outer peripheral surface of the braking part; and
the housing further includes a transparent or hollowed indicator window opened at an outer periphery corresponding to the first indicating portion and the second indicating portion of the braking part, so as to display one of the first indicating portion and the second indicating portion;
wherein when the braking part is in the released position, the first indicating portion is located at the indicator window, and when the braking part is in the locked position, the second indicating portion is located at the indicator window.

15. The parking structure according to claim 13, wherein:
the second axis is substantially perpendicular to the first axis and coincides with a rotation axis of the wheel.

16. The parking structure according to claim 4, wherein:
the drive structure includes a traction member; and
the traction member includes:
a traction member first end, joined to the drive structure;
a traction member second end, joined to the braking part; and
a traction member engagement portion, capable of being engaged in the clamping part;
wherein when the clamping part is in the blocked position, the clamping part pulls the traction member through the traction member engagement portion, so as to prevent the braking part from moving back from the locked position corresponding to the blocked position to the released position.

17. The parking structure according to claim 4, wherein:
the parking structure further includes:
a clamping part elastic member, disposed between the clamping part and the housing or the wheel seat connected to the housing, and biasing the clamping part to the first axial position; and
a locking pin elastic member, disposed between the a locking pin and the housing, and biasing the locking pin to be retracted into the housing.

18. The parking structure according to claim 3, wherein:
the drive structure includes:
a sleeve, arranged in a lateral direction on a crossbeam of the frame connected to the wheel;
a pedal, sleeved outside the sleeve, capable of being stepped to rotate around the sleeve, a pedal channel is arranged on an inner wall of the pedal, and the pedal channel includes a slanted portion extending perpendicular to the lateral direction; and
a slider, disposed slidably along the lateral direction in sleeve, a slider pin is inserted into the slider, and one end of the slider pin is inserted into the pedal channel and capable of moving relatively in the pedal channel; and
wherein when the pedal is stepped, interaction between the slider pin and the pedal channel causes the slider to pull a traction member of the drive structure toward a center of the sleeve.

19. The parking structure according to claim 18, characterized wherein:
the drive structure further includes:
an abutting member, the abutting member and the pedal are respectively formed into semi-cylindrical bodies, such that they are capable of being abutted with each other to form a tubular structure and sleeved outside the sleeve together; and
an abutting member channel is disposed on an inner side of the abutting member and extends obliquely in a direction opposite to the pedal channel, and another end of the slider pin is inserted into the abutting member channel and capable of moving relatively in the abutting member channel.

20. A child stroller comprising:
a frame;
at least one wheel, joined below the frame; and
the parking structure according to claim 1.
